(19) United States
(12) Patent Application Publication
(10) Pub. No.: US 2017/0034307 A1
(43) Pub. Date: Feb. 2, 2017

(54) METHOD AND APPARATUS FOR APPLICATION OF CONFIGURATION SETTINGS TO REMOTE DEVICES

(71) Applicant: 42 Gears Mobility Systems Pvt Ltd, Bangalore (IN)

(72) Inventors: Onkar Parhar SINGH, Fremont, CA (US); Prakash GUPTA, Bangalore (IN)

(21) Appl. No.: 15/222,664

(22) Filed: Jul. 28, 2016

(30) Foreign Application Priority Data
Jul. 28, 2015 (IN) 3867/CHE/2015

(51) Int. Cl. H04L 29/08

(52) U.S. Cl. CPC H04L 67/34

(57) ABSTRACT

Embodiments of the present invention provide a method and apparatus for application of configuration settings to remote devices. The method comprises receiving from a master device, at least one setting for being applied to at least one slave device, and sending the at least one setting from the server to the at least one slave device for being applied to the at least one slave device.

### CROSS-REFERENCE TO RELATED APPLICATIONS

This application claims priority to the Indian Provisional Application and the Indian Nonprovisional Application, having the same Application Number 3867/CHE/2015 filed on Jul. 28, 2015, and both are herein incorporated by reference in their entirety.

### FIELD OF THE INVENTION

Embodiments of the present invention generally relate to management of multiple remote devices, and more particularly to a method and apparatus for application of configuration settings to remote devices.

### BACKGROUND

Computing devices such as computers, smartphones, tablets, wearables, virtual reality displays, gaming consoles, among several others are ubiquitous in routine activities. In several scenarios, for example, in a corporate environment, multiple devices are provided to employees and management. Such multiple devices may need to be managed, for example, by an administrator, who is remote to the multiple devices.

Further, within the multiple devices are devices of varied types, including those mentioned above, and several other prevalent devices. It is cumbersome for an administrator to keep track of multiple such devices, or to keep track of which devices need to be managed, which configuration settings to apply, and specific configuration settings that may be appropriate for such devices.

Therefore, there exists a need in the art for a method and apparatus for application of configuration settings to remote devices.

### SUMMARY

Embodiments of the present invention provide a method and apparatus for application of configuration settings to remote devices, substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts an apparatus for application of configuration settings to remote devices, according to one or more embodiments.

FIG. 2 depicts a flow diagram of a method for application of configuration settings to remote devices, according to one or more embodiments.

FIG. 3 depicts a flow diagram of a method for generating a profile for application of configuration settings to remote devices, according to one or more embodiments.

FIG. 4 depicts a flow diagram of a method for capturing settings for application of configuration settings to remote devices, according to one or more embodiments.

### DESCRIPTION

Embodiments of the present invention provide a method and an apparatus for application of configuration settings to remote devices, by capturing a setting applied at a master device via an agent on the master device, sending the captured setting to a server, which pushes the setting to one or more slave devices, and an agent on each of the one or more slave devices applies or provisions the setting captured at the master device, to the slave device. The agent on the slave device sends a confirmation to the server that the setting has been applied or provisioned. The master device may be similar to the slave devices pertaining to the settings that are captured at the master device for applying to the slave devices. For example, for visual settings such brightness, screen resolution, icon size and the like, the master device and slave devices may have a similar screen. In this example, by first applying the setting to the master device, the administrator initiating the application of the captured setting on the master device is able to visualize how the captured setting, when applied, will appear on the slave devices. Similarly, in examples, where the setting is a software related setting, the master device and the slave devices have a similar operating system environment, so that by first applying software related setting and possibly verifying that the setting works as intended, the administrator is able to visualize the user experience for the setting captured at the master device, as applied to the slave devices. Such a visualization assists the administrator to apply settings to the slave devices in an effective manner, avoiding iterations that may be otherwise required.

For example, if a setting pertaining to an icon size or brightness is made from a personal computer having an LCD monitor and a resolution of 1080×960 acting as the master device, to a smartphone having an OLED screen with a resolution of 750×1334, the administrator applying a brightness setting or an icon size setting would not see on the master device similar brightness or icon size, respectively. However, if the master device and the slave devices have a similar screen and similar resolution, then a setting with respect to brightness or icon size applied at the master device will provide the administrator a good visualization estimate of how the settings would appear when applied or provisioned to the slave devices.

Embodiments of the invention may utilize profiles, where each profile associates a group of settings with a group of slave devices. When a setting captured at the master device is sent, for example, for applying to a slave device, the setting is matched to one or more profiles containing the captured setting, and sent to the corresponding slave devices for application. Profiles may also include an association with one or more master devices, so that only select master devices may initiate application of settings using the profiles.

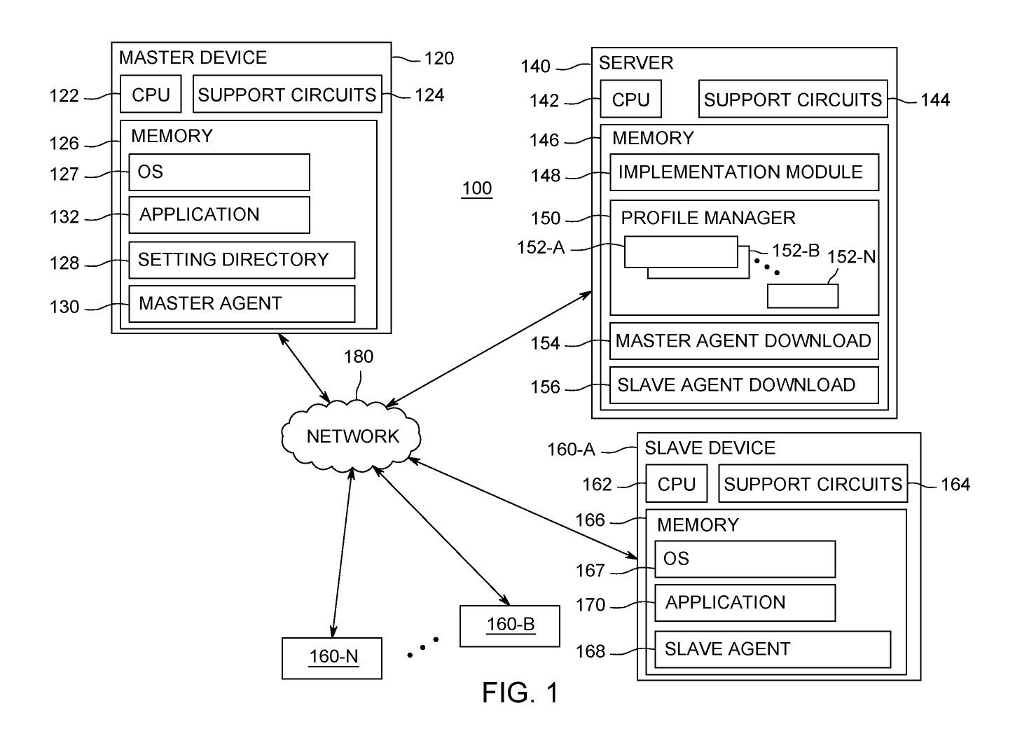

FIG. 1 depicts an apparatus 100 for application of configuration settings to remote devices, according to one or more embodiments. The apparatus 100 comprises a master device 120, a server 140, multiple slave devices 160-A, 160-B, . . . 160-N (or generally referred to by the numeral 160), each communicably coupled via a network 180.

The master device 120 may be a computer, laptop, tablet, or any other digital processing device as generally known in the art. The master device 120 comprises a CPU 122, support circuits 124 and a memory 126. The CPU 122 may be any commercially available digital processor, microprocessor, microcontroller, and the like. The support circuits 124 comprise well-known circuits that provide functionality to the CPU 122 such as a user interface, clock circuits, network communications, cache, power supplies, I/O circuits, and the like. In some embodiments, the user interface comprises a keypad, electronic buttons, dials, speaker, touchscreen, display, or other user interaction mechanism for programming or otherwise operating the master device 120. Alternative embodiments may use control algorithms on a custom Application Specific Integrated Circuit (ASIC) to implement the functionality afforded by the CPU 122, the support circuits 124, and the memory 126.

The memory 126 may be any form of digital storage used for storing data and executable software or programming instructions. The memory 126 includes, but is not limited to, random access memory, read only memory, disk storage, optical storage, and the like. The memory 126 comprises an operating system (OS) 127, a settings directory 128, a training module 130, and an application 132. The OS 127 is an operating system as generally known in the art, for example, ANDROID, IOS, LINUX, WINDOWS, among others, and among performing several other functions, allow configuration of the master device 120 or any attribute thereof, via one or more settings pertaining to the master device 120, for example, settings pertaining to the CPU 122, the support circuits 124, the memory 126 or application (application 132) stored thereon. Settings are applied to the master device 120 or the application 132 in manners generally know in the art, for example, via user interfaces provided by the OS 127 or the application 132 for the purpose of configuring the related settings. Setting include, without limitation, settings related to the CPU 122, for example, the clock speed, related to the support circuits 124, for example, the network transceiver power, screen brightness, resolution, icon size, related to the memory 126, for example, folder size for temporary files or files of a particular type, among several other settings available and/or possible. A non-exhaustive list of settings includes network related settings such as WiFi Access Point Names, Wifi Secret key, Wifi Encryption type, IP Address, domains and sub-domains; Email related configurations such as email address, email incoming/outgoing server path, email password, email ID, associated ports; VPN related configuration such as VPN protocol, VPN server path, VPN credentials; Mobile network related configuration such as mobile access point name, mobile data enable/disable, mobile roaming enable/disable; Phone related settings such as add/edit/delete contacts, ringtone, phone volume; OS related settings such as enable/disable Over The Air updates; and other settings related to application(s) installed on a device.

The settings directory 128 includes an active list of one or more settings from an exhaustive number settings possible for the master device 120 that are available for being sent to the slave devices 160 for application on the slave devices 160. The settings directory 128 further includes a reference to one or more profiles (discussed later with respect to the server 140 and profiles 152) associated with the one or more settings of the active list. If a new setting from the settings directory is identified for being applied to the slave devices, either an existing profile (using a reference thereto) is associated with the new setting, or a new profile is generated. The new profile is generated, for example, at the server 140 in response to a request from the master device 120 to generate the new profile, and reference to the new profile is provided to the settings directory 128 to associate the reference to the new setting. New profiles are generated in the manner as discussed below, for example, with respect to the server 140. The settings directory 128 may be configured by an administrator of the master device 120, on the master device 120, or on the server 140, from where the settings directory may be synchronized between the master device 120 and the server 140. Settings from the settings directory 128, when applied to the master device 120, are captured by the master agent 130, along with an associated profile. In case multiple profiles are associated with a particular setting, one may be selected based on predefined conditions, for example, configured by the administrator. The master agent 130 listens for the one or more settings from the settings directory 128 being applied to the master device 120, via an application programming interface (API) of the OS 127, or an API of the application 132, among several other tracking mechanisms known in the art. The master agent 130 is capable of identifying the application of the setting and the details of the settings instantaneously, that is, upon the occurrence of application of the setting. Upon identifying that one of the settings listed in the settings directory 128 has been applied to the master device 120, the master agent 130 captures the applied setting including the associated profile reference, and sends the captured setting to the server 140, for example, for being applied to one or more slave devices 160.

In some embodiments, the master agent 130 sends the one or more settings to the server 140 based on the occurrence of the application of the setting at the master device 120, that is immediately upon detection that the setting has been applied. In some embodiments, the master agent 130 sends the settings to the server 140 according to a defined schedule, for example, the master agent 130 accumulates all the settings applied to the master device 120 in a predefined time period, and then sends all the settings at the end of the predefined time period to the server 140. In some embodiments, the master agent 130 sends the settings according to availability of connectivity to the server 140, for example, the network 180 being active. In some embodiments, the settings are sent to the server 140 based on request made by the server 140, which request may be an ad hoc or a scheduled request. In some embodiments the request from the server 140 is based on a request from one or more slave devices 160. In some embodiments, the settings are sent to the server 140 based on an instruction captured on the master device, for example, via a gesture (for example, tap or swipe on a touchscreen) on a graphical user interface (GUI) on the master device 120, via a text command typed into a command console (for example, an MS DOS command), among several other instruction mechanisms as known in the art. Such instructions may be input by an administrator of the master device 120, for example. According to one or more embodiments, the master agent 130 sends the setting to the server 140 based on one or more embodiments discussed above, as can be configured in the master agent 130, for example, as preferences by the administrator.

Further, according to some embodiments, the master agent 130 attaches provisioning information with the setting sent to the server 140. The provisioning information includes information required to apply the setting to a slave device 160 in a manner replicative of the setting applied on the master device 120, for example, a configuration of OS 127, application 132 or APIs thereof. The provisioning information includes a timeframe preference for the setting to be applied to the slave devices 160 based on the settings sent from the master device 120 to the server 140. For example, timeframe preferences include applying the settings to the slave devices 160 immediately upon the setting being applied to the master device 120, according to a predefined time schedule, according to the availability of connectivity to the network 180, based on a request from the slave devices 160, among several other preferences that will occur to those skilled in the art without departing from the scope and the spirit of the present invention.

The server 140 may be a computer, laptop, tablet, or any other digital processing device as generally known in the art. The server 140 comprises a CPU 142, support circuits 144 and a memory 146. The CPU 142 may be any commercially available digital processor, microprocessor, microcontroller, and the like. The support circuits 144 comprise well-known circuits that provide functionality to the CPU 142 such as a user interface, clock circuits, network communications, cache, power supplies, I/O circuits, and the like. In some embodiments, the user interface comprises a keypad, electronic buttons, dials, speaker, touchscreen, display, or other user interaction mechanism for programming or otherwise operating the server 140. Alternative embodiments may use control algorithms on a custom Application Specific Integrated Circuit (ASIC) to implement the functionality afforded by the CPU 142, the support circuits 144, and the memory 146.

The memory 146 may be any form of digital storage used for storing data and executable software or programming instructions. The memory 146 includes, but is not limited to, random access memory, read only memory, disk storage, optical storage, and the like. The memory 146 comprises computer readable instructions corresponding to an operating system (not shown), an implementation module 148, a profile manager 150 comprising multiple profiles 152-A, 152-B, . . . 152-F (or generally referred to by the numeral 152), a master agent download 154, and a slave agent download 156.

The implementation module 148 receives one or more settings from the master device 120, for example, the settings sent from the master device 120 to the server 140 for being applied to one or more slave devices 160. Upon receipt of the settings from the master device 120, the implementation module 148 sends the settings to one or more slave devices 160 for being applied to the one or more slave devices 160. According to some embodiments, the implementation module 148 sends the settings received from the master device 120 for being applied to the slave devices 160, immediately upon receipt of such settings. In some embodiments, the implementation module 148 sends the setting to the slave devices 160 based on a predefined schedule, based on a request for settings received by the slave device 160, availability of connectivity to the network 180, among other schemes that will occur to those skilled in the art without departing from the scope and the spirit of the present invention.

According to some embodiments, the implementation module 148 sends the settings based on the provisioning preferences, for example, as described above, received from the master device 120. In some embodiments, provisioning preferences are provided via the server 140, and may override or be overridden by the provisioning preferences, if received from the master device 120, according to a predefined preference, for example, as configured by an administrator. Upon sending the settings to the slave devices 160, the implementation module 148 listens for a confirmation from the slave devices 160 that the setting sent to the slave devices 160 has been applied successfully to the slave devices 160. According to some embodiments, the implementation module 148 further displays the status of the application of the setting on the slave devices 160, for example, based on whether the confirmation of the application of the setting has been received from the slave device 160. In some embodiments, the implementation module 148 further sends the status of the application to the master device 120, for example, to the master agent 130.

The profile manager 150 associates the settings, for example, the settings (applied on the master device 120) received from the master device 120 for application to the slave devices 160 with the slave devices 160 to generate the one or more profiles 152. The profile manager 150 generates a profile associating at least one setting with one or several slave devices, which association may be made via a GUI on the server 140 or a GUI on the slave devices 160. In some embodiments, the profile manager 150 generates profiles based on a request received from the master device 120, along with the at least one setting. The profile is usable, for example, by the implementation module 148, to send the settings received from the master device 120 to the associated slave devices 160. For example, of all the slave devices 160, it may be desirable that a particular setting only be applied to a select group of the slave devices 160. In this example, the particular setting is associated with the select group of slave devices and stored as a profile, for example the profile 152-A. Several similar profiles 152 may be generated based on the defined preferences, for example, by the administrator. In some embodiments, continuing the example above, the administrator registers the slave device to an existing profile, say 152-A, by accessing the profile manager 150 from each slave device (for example, a GUI of the slave device) from the select group of slave devices, and associating the particular profile 152-A with each such slave device. In some embodiments, the administrator generates the profiles via the server 140, for example using a GUI of the server 140 to associate a setting with a unique identifier (such as a MAC address or another unique identifier associated with the slave device) of the desired slave device. In this manner, profiles 152 associating one or more settings to one or more slave devices 160 are generated, and in some embodiments, the profiles 152 are stored on the server 140.

In the embodiments in which profiles are used, for example, defined by preferences configured by the administrator, the implementation module 148 consults with the profile manager 150 upon receiving a setting from the master device 120, and identifies the relevant profile(s) 152 for the received setting. The implementation module 148 sends the setting to only those slave devices that are associated with the identified relevant profile(s), for example, as defined above.

In some embodiments, the master device 120 (from a group of several master devices, not shown in the drawings) is further associated to one or more of the profiles 152, for example, in a manner similar to the association of the slave devices 160. In such embodiments, the implementation manager 148 consults the profile manager 150 to identify profile(s) that include the settings and the master device 120, and sends the settings to only those slave devices that are associated with the identified relevant profile(s).

The master agent download 154 and the slave agent download 156 are computer readable instructions corresponding to the master agent 130 and slave agent 160 (discussed below), respectively. In one embodiment, the master agent download 154 may be downloaded and installed on the master device 120 as the master agent 130. In another embodiment, the master agent download 154 is rendered via a browser (not shown) resident on the master device 120. The master agent download 154 may be stored on the server 140 or any other device communicably coupled to the master device. Similar configurations apply to the slave agent download 156.

The slave devices 160, for example, the slave device 160-A, may be a computer, laptop, tablet, or any other digital processing device as generally known in the art. The slave device 160 comprises a CPU 162, support circuits 164 and a memory 166. The CPU 162 may be any commercially available digital processor, microprocessor, microcontroller, and the like. The support circuits 164 comprise well-known circuits that provide functionality to the CPU 162 such as a user interface, clock circuits, network communications, cache, power supplies, I/O circuits, and the like. In some embodiments, the user interface comprises a keypad, electronic buttons, dials, speaker, touchscreen, display, or other user interaction mechanism for programming or otherwise operating the slave device 160. Alternative embodiments may use control algorithms on a custom Application Specific Integrated Circuit (ASIC) to implement the functionality afforded by the CPU 162, the support circuits 164, and the memory 166.

The memory 166 may be any form of digital storage used for storing data and executable software or programming instructions. The memory 166 includes, but is not limited to, random access memory, read only memory, disk storage, optical storage, and the like. The memory 166 comprises an operating system (OS) 167, a slave agent 168, and an application 170.

The OS 167 is an operating system as generally known in the art, for example, ANDROID, IOS, LINUX, WINDOWS, among others, and among performing several other functions, allows configuration of the slave device 160 or any attribute thereof, via one or more settings pertaining to the slave device 160, and as received from the master device 120 via the serve 140. For example, settings pertain to the CPU 162, the support circuits 164, the memory 166 or the application 170, which corresponds to the application 132 of the maser device 120 stored thereon.

The slave agent 168 receives the settings, as applied on the master device 120, to be applied on the slave device 160. The settings are received on the slave device 160 from the server 140 in the manner described above. The slave agent 168 applies the setting to the slave device 160 in a manner generally known in the art, for example, using API of the OS 167 or an API of the application 170. In some embodiments, the slave agent 168 further utilizes the provisioning information generated by the master device 120, if received along with the setting, in order to apply the settings to the slave device 160. Upon successful completion of the application of the setting, the slave agent 168 sends a confirmation of such application to the server 140, for example, to the implementation module 148.

According to some embodiments, a user of the slave device 160 may request for a setting via the slave agent 168, for example by manipulating a GUI of the slave device 160. In some embodiments, the slave agent 168 queries the server 140 to check if an updated setting for being applied to the slave device 160 exists. In some embodiments, the slave agent 168 checks for a setting based on a predefined schedule or based on available connectivity with the network 180.

In some embodiments, the network 180 includes one or more networks including but not limited to Local Area Networks (LANs) (e.g., an Ethernet or corporate network), Wide Area Networks (WANs) (e.g., the Internet), wireless data networks, cellular networks, Wi-Fi, Bluetooth, or some other electronic data communication network, or a combination thereof.

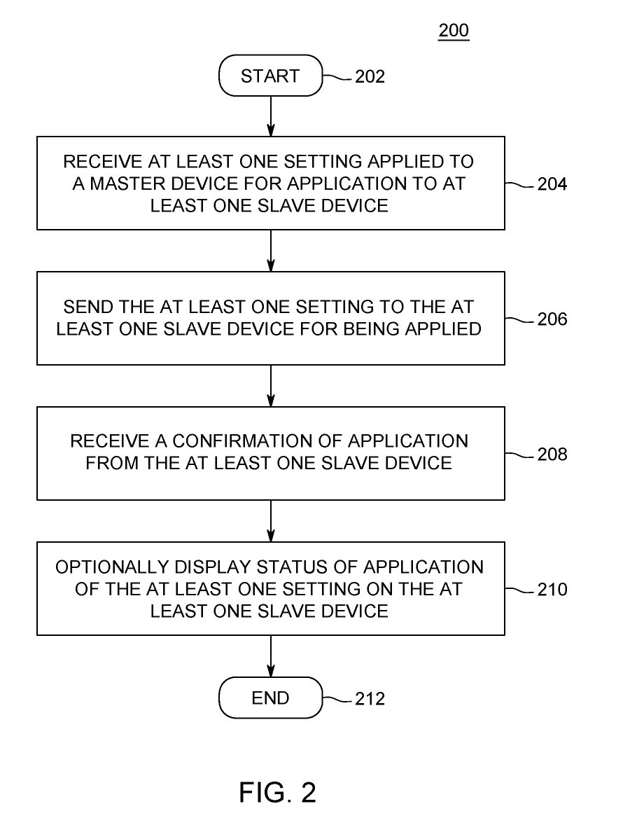

FIG. 2 depicts a flow diagram of a method 200 for application of configuration settings to remote devices, according to one or more embodiments. The method 200 is performed by the server 140, and for example, by the implementation module 148. The method 200 begins at step 202, and proceeds to step 204, at which the method 200 receives a setting from the master device 120 for being applied to at least one slave device 160-A, for example. The setting received from the master device 120 is a setting which has been applied to the master device 120, and is sent by the master agent 130 of the master device 120, for example, as discussed above with respect to FIG. 1.

The method 200 proceeds to step 206, at which the method 200 sends the setting from the server 140 to the slave device 160-A for being applied to the slave device 160-A. In some embodiments, the settings are sent to the slave agent 168 of the slave device 160, for example, as discussed with respect to FIG. 1. For example, the settings may be sent immediately, according to a predefined schedule, request from the slave device 160 or availability of connectivity to the network 180. In some embodiments, the settings are sent to specific slave devices according to profiles, as discussed with respect to FIG. 1.

The method 200 proceeds to step 208, at which the method 200 receives a confirmation from the slave agent 168 of the slave device 160-A that the setting has been applied to the slave device 160-A successfully. The method 200 proceeds to optional step 210, at which the method 200 displays the status of the application of the setting on the slave device 160-A. The method 200 proceeds to step 212, at which the method 200 ends.

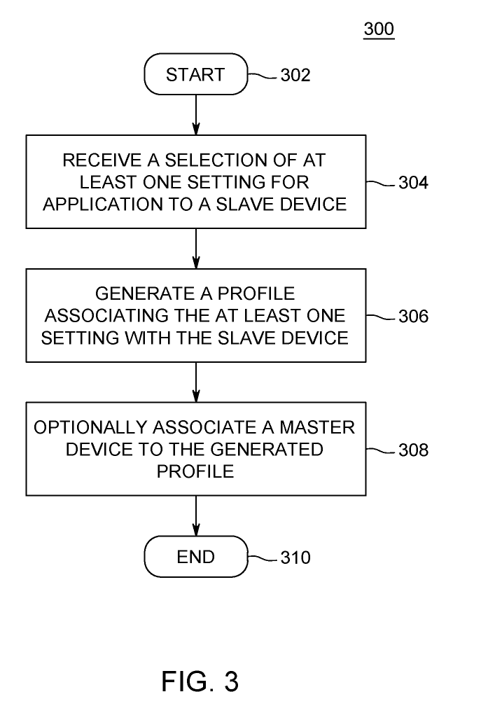

FIG. 3 depicts a flow diagram of a method 300 for generating a profile, for example, profiles 152, for application of configuration settings to remote devices, according to one or more embodiments. The method 300 is performed by the server 140, and for example, by the profile manager 150. The method 300 begins at step 302, and proceeds to step 304, at which the method 300 receives a selection or an input of a setting for being applied to at least one slave device, for example, the slave device 160-A. The method 300 proceeds to step 306, at which the method 300 generates a profile associating the setting and the slave device 160-A. The profile may be stored at the server 140, for example as profile 152-A. The method 300 proceeds to optional step 308, at which the method 300 further associates a master device, for example, the maser device 120 with the profile including one or more settings and one or more slave devices, for example, as generated using steps 304 and 306. The method 300 proceeds to step 310, at which the method 300 ends.

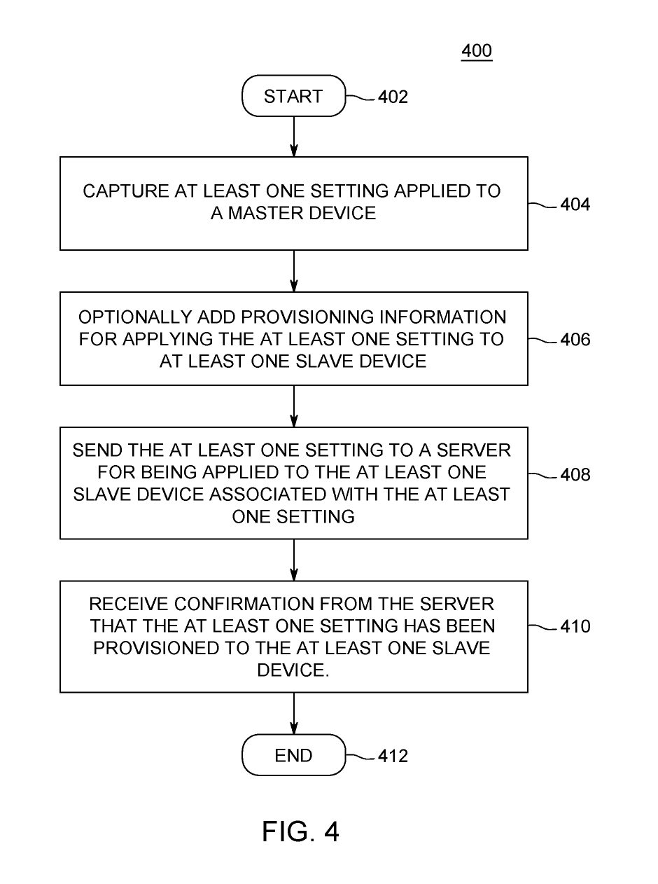

FIG. 4 depicts a flow diagram of a method 400 for capturing settings for application of configuration settings to remote devices, according to one or more embodiments. The method 400 is performed by a processor executing the instructions in the master agent download 154, for example, downloaded and executed on the master device 120, or executed on the server 140 and rendered via a browser (not shown) on the master device 120. The method 400 begins at step 402, and proceeds to step 404, at which the method 400 captures a setting applied to the master device 120 for applying the setting to a slave device 160-A. The setting is applied to the master device 120, for example, by an administrator using the various user interfaces and modes available on the master device 120, for example as described with respect to FIG. 1. The method 400 proceeds to optional step 406, at which the method 400 optionally adds provisioning information for applying the setting to the slave device 160-A, as described with respect to FIG. 1. The method 400 proceeds to step 408, at which the method 400 sends the setting, as applied to the master device 120, to the server 140 for being applied to the slave device 160-A associated with the setting. The method 400 proceeds to step 410, at which the method 400 receives confirmation from the server that the setting has been applied to the slave device 160-A successfully. The method 400 then proceeds to step 412, at which the method 400 ends.

Embodiments described herein enable replication of settings applied to a master device at the slave device. Applying the settings at the master device enables a person configuring the setting, such as an IT administrator, to visualize the setting as the setting will be experienced on the slave device, for example, by a user of the slave device. Such a visualization is indispensable in reducing and/or eliminating iterations required for achieving an acceptable or effective configuration of a desired setting. Particularly, the embodiments described herein present significant advantage over solutions in which an IT administrator pushes settings, such as brightness and icon size, to slave devices such as a smartphone or a tablet, from a console or a control panel on a personal computer which does not replicate the graphical environment of the slave device visually. It is very difficult, if not impossible, for the IT administrator to visualize from such a console or a control panel, how settings such as brightness and icon size, will appear and function on a target slave device and hence requires multiple iterations to come up with a good settings configuration. Embodiments described herein enable an IT administrator to define a good settings configuration on a master device, verify that settings such as brightness and icon size are configured satisfactorily, and send that setting for being applied to slave devices having a similar pertinent configuration with respect to the setting (e.g. for brightness, the pertinent configuration is the type of screen, for icon size, the pertinent configuration is the screen resolution and screen size) of the master device.

The settings applied to the master device may be replicated at the slave device(s) associated with the settings and/or the master device, for example using a profile, immediately upon application of the settings at the master device, based on a predefined schedule, availability of the network interconnecting the master device, the server and the slave device(s), a request from the server and/or the slave device(s), or a combination thereof.

According to some embodiments, the master device is identical to the slave devices, and therefore, a setting applied at the master device and replicated at the slave devices is applied in identical environments, allowing an administrator configuring the settings via the master device to visualize the applied settings on the slave devices precisely. According to some embodiments, the master device and the slave devices are similar, that is similar visually, in processing power, in memory capability, network connectivity, any other configurable parameter of the devices, or a combination thereof. According to some embodiments, the master device is similar only with respect to a particular setting that is applied at the master device and replicated at the slave devices. For example, if the setting relates to network configuration, then the master and slave devices have network adapters with identical or similar configurations.

According to various embodiments, the settings are applied to the slave devices in a manner similar to the application of the settings on the master device. This is enabled by the master and slave agents which correspond to each other, and are capable of replicating the application of the settings at the slave device. In some embodiments, the implementation module acts as pass through between the master agent and the slave agent(s), pushing forward to the slave agent(s), the settings received from the master agent.

The techniques and elements described with respect to one embodiment may be combined with the techniques and elements of other embodiments, and all such combinations will occur readily to those skilled in the art without departing from the scope or the spirit of the present invention, as defined by the claims.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for application of configuration settings to remote devices, comprising:
receiving, at a server, from a master device, at least one setting for being applied to at least one slave device; and
sending the at least one setting from the server to the at least one slave device for being applied to the at least one slave device.

2. The method of claim 1, further comprising:
receiving a confirmation from the at least one slave device that the at least one setting has been applied to the at least one slave device.

3. The method of claim 1, wherein the at least one setting corresponds to a setting applied at the master device.

4. The method of claim 3, wherein the master device has a hardware configuration identical to the hardware configuration of the at least one slave device.

5. The method of claim 1, further comprising generating a profile associating the at least one setting and the at least one slave device.

6. The method of claim 5, wherein the associating is based on an input from the at least one slave device, the input identifying the at least one setting, the at least one slave device, or both.

7. The method of claim 6, further comprising associating the master device to the profile.

8. The method of claim 1, wherein the at least one setting is received at the server based on at least one of a tap entered via a touchscreen on the master device, application of the at least one setting at the master device, a scheduled push of the at least one setting from the master device, a scheduled request for providing the at least one setting sent from the server to the master device, or a server request for providing the at least one setting sent from the server to the master device based on a slave device request for the at least one setting received by the server from at least one slave device.

9. The method of claim 1, wherein the at least one setting is sent by the server based on at least one of a request for the at least one setting by the at least one slave device, or immediately upon receipt of the at least one setting from the master device.

10. An apparatus for application of configuration settings to remote devices, comprising at least one processor, and a memory comprising executable instructions, which when executed via the at least one processor implement a method comprising:
receiving, at a server, from a master device, at least one setting for being applied to at least one slave device; and
sending the at least one setting from the server to the at least one slave device for being applied to the at least one slave device,
wherein the at least one setting corresponds to a setting applied at the master device.

11. The apparatus of claim 10, further comprising:
receiving a confirmation from the at least one slave device that the at least one setting has been applied to the at least one slave device.

12. The apparatus of claim 10, further comprising generating a profile associating the at least one setting and the at least one slave device.

13. The apparatus of claim 12, wherein the associating is based on an input from the at least one slave device, the input identifying the at least one setting and the at least one slave device.

14. The apparatus of claim 12, further comprising associating the master device to the profile.

15. The apparatus of claim 10, wherein the at least one setting is received at the server based on at least one of a tap entered via a touchscreen on the master device, application of the at least one setting at the master device, a scheduled push of the at least one setting from the master device, a scheduled request for providing the at least one setting sent from the server to the master device, or a server request for providing the at least one setting sent from the server to the master device based on a slave device request for the at least one setting received by the server from at least one slave device.

16. The apparatus of claim 10, wherein the at least one setting is sent by the server based on at least one of a request for the at least one setting by the at least one slave device, or immediately upon receipt of the at least one setting from the master device.

17. A non-transitory computer readable media comprising processor executable instructions, which when executed using at least one processor perform a method for application of configuration settings, the method comprising:
capturing at least one setting applied to a master device;
sending the at least one setting to a server for being applied to at least one slave device associated with the at least one setting; and
receiving confirmation from the server that the at least one setting has been applied to the at least one slave device.

18. The computer readable media of claim 17, wherein the capturing comprises using at least one of an application programming interface (API) of an operating system (OS) of the master device, an API of an application on the master device, or an interface of the OS.

19. The computer readable media of claim 17, wherein the sending the at least one setting to the server is based on at least one of a tap entered via a touchscreen on the master device, capture of the at least one setting at the master device, a schedule to the at least one setting, a request for providing the at least one setting received from the server, or a server request for providing the at least one setting received from the server based on a slave device request for the at least one setting sent by at least one slave device to the server.

20. The computer readable media of claim 17, wherein the method further comprises adding provisioning information to the at least one setting, the provisioning information for applying the at least one setting to the at least one slave device.
